(19) United States
(12) Patent Application Publication
(10) Pub. No.: US 2011/0221185 A1
(43) Pub. Date: Sep. 15, 2011

(54) CONNECTION MECHANISMS INCLUDING ROTATABLY COUPLED MEMBERS

(76) Inventor: James Lu, Fremont, CA (US)

(21) Appl. No.: 12/723,482

(22) Filed: Mar. 12, 2010

(51) Int. Cl. F16L 27/00; F16C 11/00; H01R 11/00

(52) U.S. Cl. 285/272; 403/72; 439/502

(57) ABSTRACT

A joint connector including a first member and a second member, the second member being rotatably coupled with the first member. The first member may include a first-member top surface, a first-member bottom surface, and a first passageway structure disposed between the first-member top surface and the first-member bottom surface. The second member may include a second-member top surface, a second-member bottom surface, and a second passageway structure connected to the first passageway structure and disposed between the second-member top surface and the second-member bottom surface. Whenever the first passageway structure is parallel to the second passageway structure, the first-member top surface and the second-member top surface share a first imaginary tangent plane, and the first-member bottom surface and the second-member bottom surface share a second imaginary tangent plane.

### BACKGROUND OF THE INVENTION

The present invention is related to connection mechanisms. In particular, the invention is related to connection mechanisms having rotatably coupled members. For example, the invention may be related to joint connectors which include swiveling parts. Connection mechanisms, such as joint connectors, may be found in various applications. For example, a joint connector may be employed for connecting a fluid-driven tool (e.g., a pneumatic tool, a hydraulic tool, or a sprinkler) to fluid-transmitting hose. Typically, a joint connector may include a first member for connecting to the tool and a second member for connecting to the hose. The first member may be rotatably coupled with the second member for enabling the tool to swivel with respect to the hose, thereby providing additional flexibility and maneuverability when the tool is used in performing various tasks.

FIG. 1 shows a schematic representation illustrating a perspective view of an example prior-art connection mechanism 100. Connection mechanism 100 may include a first member 110 having a connecting structure 114 for coupling connection mechanism 100 with a fluid-driven tool. Connection mechanism 100 may also include a second member 120 having a connecting structure 124 for coupling connection mechanism 100 with a fluid-transmitting hose. In general, first member 110 may be rotatably coupled with second member 120 through a high-precision screw and a set of high-precision mating thread. The high-precision screw and the high-precision mating thread may allow first member 110 to swivel relative to second member 120, while preventing or minimizing fluid leakage from connection mechanism 100. Typically, for satisfying the high-precision requirements associated with the screw and the mating thread, high material, manufacturing, and/or maintenance costs of connection mechanism 100 may be incurred.

In various applications, connection mechanism 100 may be subjected to compression, which may cause substantial damage to connection mechanism 100. For example, connection mechanism 100 may be employed in a construction site or may be disposed on a driveway, where connection mechanism 100 may frequently be run over by a tire of a truck or a car. The tire may transmit a substantial portion of the weight of the truck or the car to compress and damage connection mechanism 100.

As an example, if the tire runs over connection mechanism 100 when the surface 116 (hidden behind the surface 112 and perpendicular to surface 112) of first member 110 contacts the ground, the surface 122 of second member 120 may contact the tire to receive the pressure, and the surface 132 of first member 110 may not contact the tire to receive the load. Accordingly, second member 120 alone may be compressed between the tire and the ground, and the compression may not be shared by first member 110. As a result, the received pressure may be more than what second member 120 can withstand, and second member 120 may be prone to damage.

As another example, if the tire runs over connection mechanism 100 when the surface 126 (hidden behind the surface 122 and perpendicular to surface 122) of second member 120 contacts the ground, the feature 118 (and the surface 112) of first member 110 may contact the tire to receive the pressure, and the surface 142 of second member 120 may not contact the tire to share the load. Accordingly, first member 110 and second member 120 may be compressed in series between the tire and the ground, with each of first member 110 and second member 120 receiving the same load, and with first member 110 and second member 120 compressing each other. As a result, the received pressure may be more than what each of first member 110 and second member 120 can withstand, and both first member 110 and second member 120 may be prone to damage.

### SUMMARY

An embodiment of the present invention is related to a joint connector including a first member and a second member, wherein the second member is rotatably coupled with the first member. The first member may include a first-member top surface, a first-member bottom surface, and a first passageway structure, wherein at least a portion of the first passageway structure is disposed between the first-member top surface and the first-member bottom surface. The second member may include a second-member top surface, a second-member bottom surface, and a second passageway structure, wherein the second passageway structure is connected to the first passageway structure, and wherein at least a portion of the second passageway structure is disposed between the second-member top surface and the second-member bottom surface. Whenever the portion of the first passageway structure is parallel to the portion of the second passageway structure, the first-member top surface and the second-member top surface share a first imaginary tangent plane, wherein the first imaginary tangent plane is a tangent to both the first-member top surface and The second-member top surface, and wherein the first imaginary tangent plane is perpendicular to both a surface normal vector of the first-member top surface and a surface normal vector of the second-member top surface. In addition, whenever the portion of the first passageway structure is parallel to the portion of the second passageway structure, the first-member bottom surface and the second-member bottom surface share a second imaginary tangent plane, wherein the second imaginary tangent plane is a tangent to both the first-member bottom surface and the second-member bottom surface, and wherein the second imaginary tangent plane is perpendicular to both a surface normal vector of the first-member bottom surface and a surface normal vector of the second-member bottom surface.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a schematic representation illustrating a perspective view of an example prior-art connection mechanism.

FIG. 2A shows a schematic representation illustrating a perspective view of a connection mechanism in accordance with one or more embodiments of the present invention.

FIG. 2B shows a schematic representation illustrating a top view of a connection mechanism in accordance with one or more embodiments of the present invention.

FIG. 2C shows a schematic representation illustrating a front view of a connection mechanism in stable equilibrium (corresponding to the top view illustrated in the example of FIG. 2B) in accordance with one or more embodiments of the present invention.

FIG. 2D shows a schematic representation illustrating a front view of a connection mechanism in stable equilibrium in accordance with one or more embodiments of the present invention.

FIG. 2E shows a schematic representation illustrating a front view of a connection mechanism in unstable equilibrium in accordance with one or more embodiments of the present invention.

FIG. 2F shows a schematic representation illustrating a front view of a connection mechanism in unstable equilibrium in accordance with one or more embodiments of the present invention.

FIG. 2G shows a schematic representation illustrating a cross-sectional view of a connection mechanism in accordance with one or more embodiments of the present invention.

FIG. 2H shows a schematic representation illustrating a cross sectional view of a member of a connection mechanism in accordance with one or more embodiments of the present invention.

FIG. 2I shows a schematic representation illustrating a top view of a coupling component of a connection mechanism in an uncompressed state in accordance with one or more embodiments of the present invention.

FIG. 2J shows a schematic representation illustrating a top view of a coupling component of a connection mechanism in a compressed state in accordance with one or more embodiments of the present invention.

FIG. 3A shows a schematic representation illustrating a top view of a coupling component of a connection mechanism in an uncompressed state in accordance with one or more embodiments of the present invention.

FIG. 3B shows a schematic representation illustrating a top view of a coupling component of a connection mechanism in a compressed state in accordance with one or more embodiments of the present invention.

FIG. 4 shows a schematic representation illustrating a perspective view of a connection mechanism in accordance with one or more embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

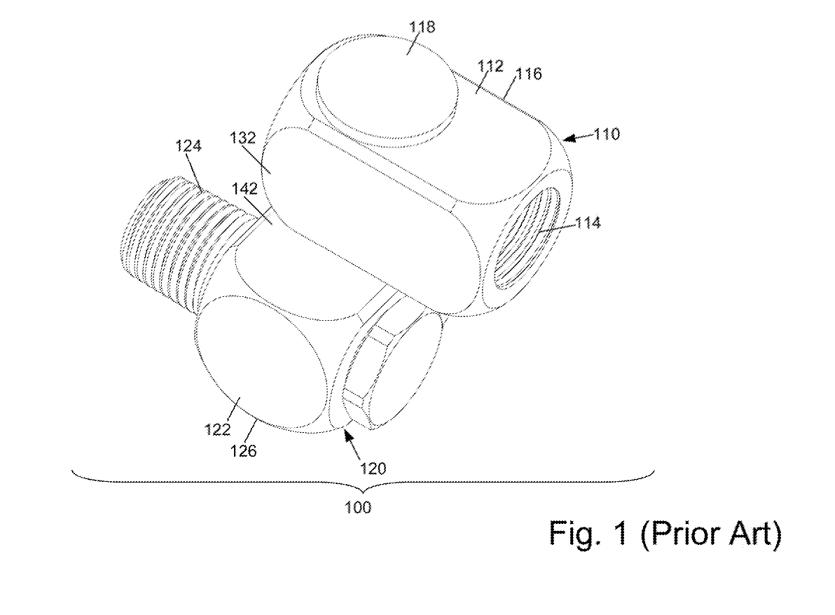

One or more embodiments of the invention are related to a connection mechanism including a first member and a second member, wherein the second member may be rotatably coupled with the first member. The first member and the second member may have coplanar points for sharing and distributing compression forces between the first member and the second member when the connection mechanism is compressed by, for example, a tire of a truck which runs over the connection mechanism. In comparison with prior-art connection mechanisms, such as connection mechanism 100 illustrated in the example of FIG. 1, with effective load sharing, the connection mechanism in accordance with one or more embodiments of the invention may be less prone to damage under compression and may be more durable.

In one or more embodiments, the first member may include a first-member top surface, a first-member bottom surface, and a first passageway structure, wherein at least a portion of the first passageway structure may be disposed between the first-member top surface and the first-member bottom surface. The first passageway structure may accommodate a fluid flow and/or may accommodate electrical connection between devices connected by the connection mechanism. The second member may include a second-member top surface, a second-member bottom surface, and a second passageway structure, wherein at least a portion of the second passageway structure may be disposed between the second-member top surface and the second-member bottom surface. The second passageway structure may be connected to the first passageway structure for accommodating the fluid flow and/or accommodating the electrical connection.

When the connection mechanism is compressed, the portion of the first passageway structure and the portion of the second passageway structure may remain parallel to each other or, given the rotatable coupling between the first member and the second member, may become parallel to each other. Whenever the portion of the first passageway structure is parallel to the portion of the second passageway structure, the first-member top surface and the second-member top surface may share a first imaginary tangent plane. The first imaginary tangent plane may be a tangent to both the first-member top surface and the second-member top surface, and the first imaginary tangent plane may be perpendicular to both a surface normal vector of the first-member top surface and a surface normal vector of the second-member top surface. As a result, a first object which exerts the compression, e.g., a tire of a truck, may contact both the first-member top surface and the second-member top surface simultaneously.

In addition, whenever the portion of the first passageway structure is parallel to the portion of the second passageway structure, the first-member bottom surface and the second-member bottom surface may share a second imaginary tangent plane. The second imaginary tangent plane may be a tangent to both the first-member bottom surface and the second-member bottom surface, and the second imaginary tangent plane may be perpendicular to both a surface normal vector of the first-member bottom surface and a surface normal vector of the second-member bottom surface. As a result, a second object which exerts the compression, e.g., the ground, may contact both the first-member bottom surface and the second-member bottom surface simultaneously.

As can be appreciated from the discussion above, each of the objects which exert the compression may contact both the first member and the second member simultaneously. As a result, the compression may be distributed and shared between the first member and the second member, and the pressure received by each of the first member and the second member may be more likely to be bearable to each of he first member and the second member. Advantageously, the connection mechanism in accordance with one or more embodiments of the invention may be less prone to damage under compression and may be more durable in comparison with prior-art connection mechanisms.

In one or more embodiments, the first member may further include a first groove structure, the second member may further include a second groove structure, and the connection mechanism may further include a coupling component for coupling the first member with the second member by engaging both the first groove structure and the second groove structure. A first portion of the coupling component may be disposed inside the first groove structure, and a second portion of the coupling component may be disposed inside the second groove structure. Engaging both the groove structures, the coupling component may securely couple the first member with the second member, preventing the first member and the second member from being separated. At the same time, the coupling component may allow the first member and the second member to swivel relative to each other.

The use of the coupling component may eliminate the need for a screw in coupling the two members of the connection mechanism. As a result, precision requirements associated with the use of a screw may be eliminated. Advantageously, manufacturing and maintenance costs associated with the connection mechanism may be minimized, and/or the quality and reliability of the connection mechanism may be economically provided.

The features and advantages of the present invention may be better understood with reference to the figures and discussions that follow.

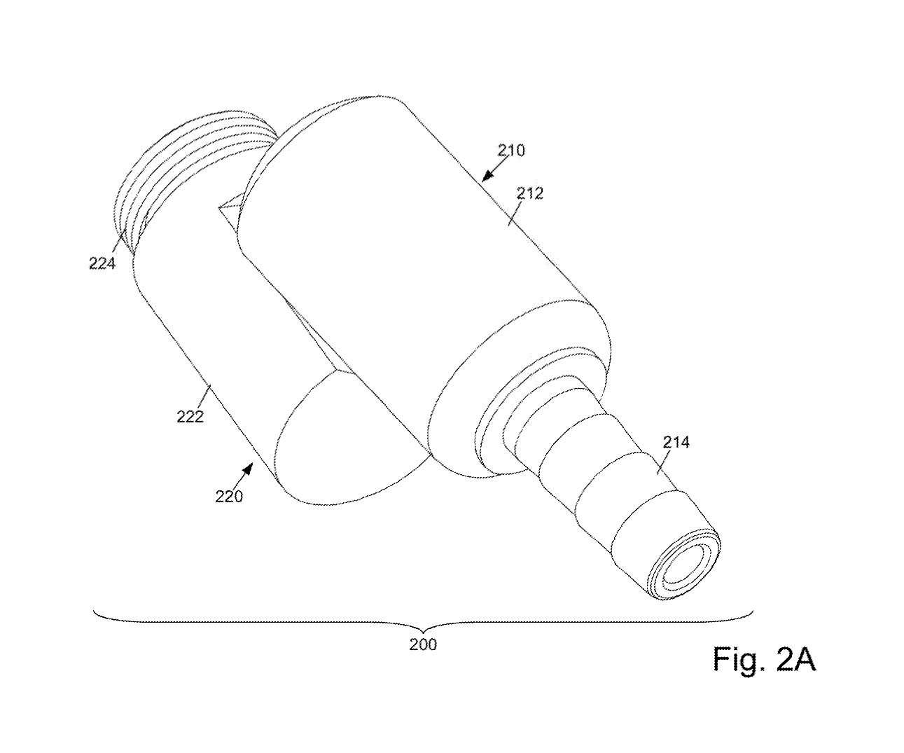

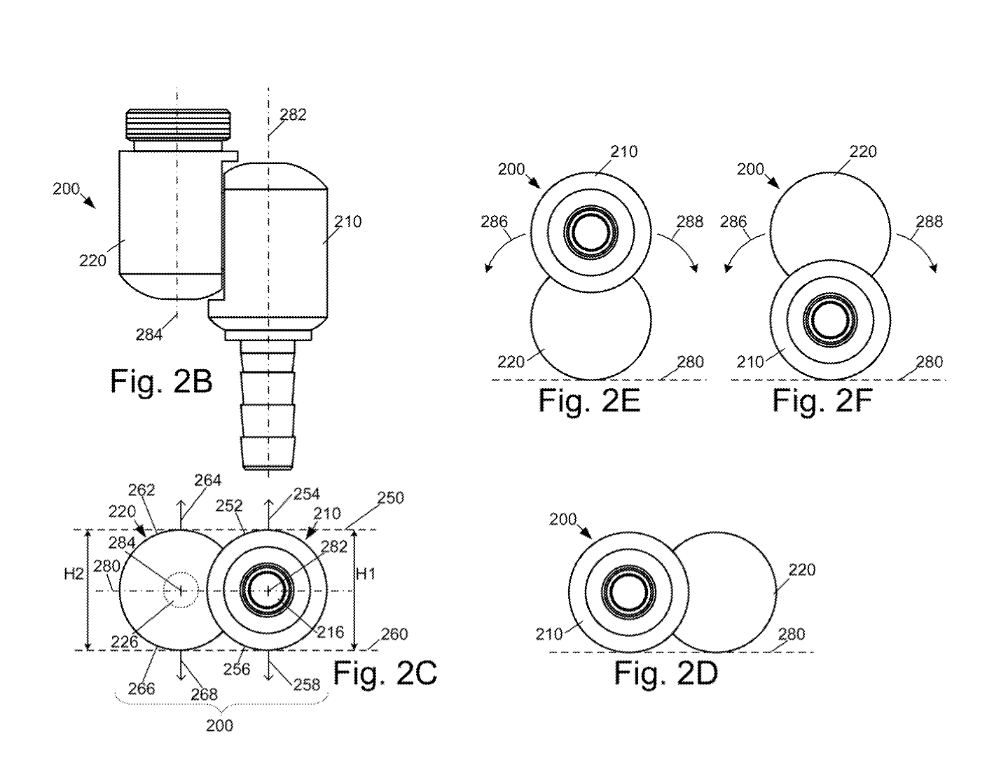

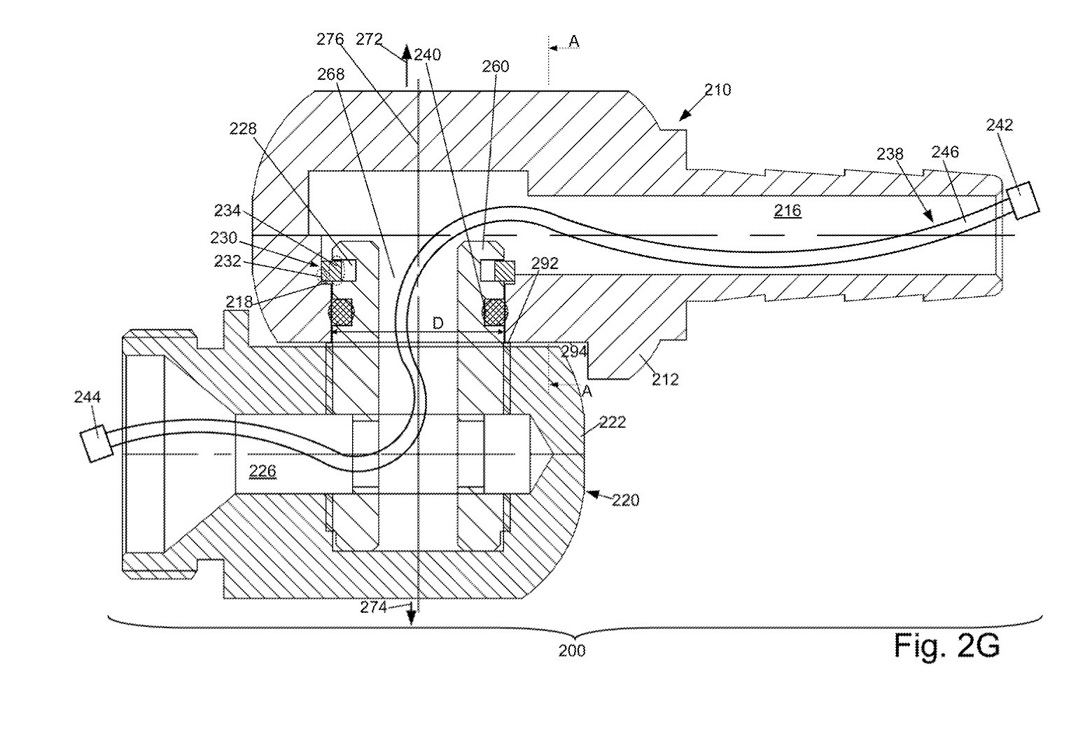

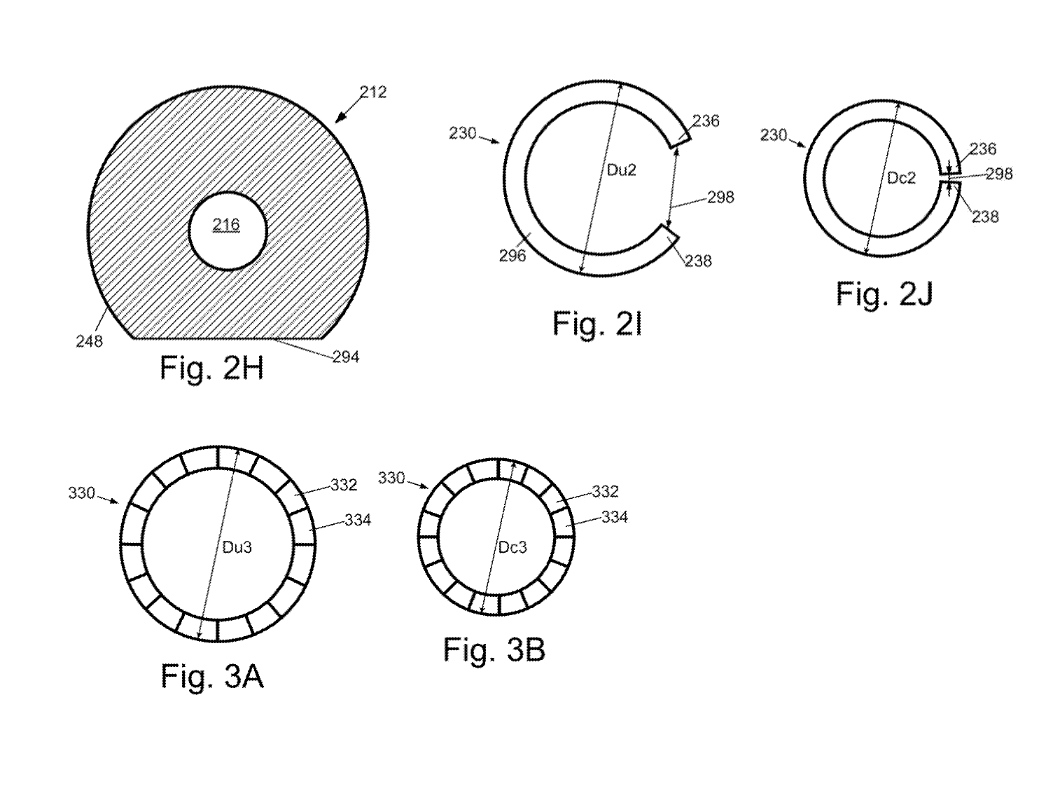

FIG. 2A shows a schematic representation illustrating a perspective view of a connection mechanism 200 in accordance with one or more embodiments of the present invention. For example, connection mechanism 200 may represent a joint connector for use in, for example, connecting a fluid-driven tool with a fluid hose, connecting a mechanical part with another mechanical part, and/or connecting an electrical part with another electrical part.

As illustrated in the example of FIG. 2A, connection mechanism 200 may include a first member 210 and a second member 220. First member 210 may include a body 212 and a connecting head 214, wherein connecting head 214 may be mechanically coupled with and/or integrated with body 212. Second member 220 may include a body 222 and a connecting head 224, wherein connecting head 224 may be mechanically coupled with and/or integrated with body 222. In one or more example applications of connection mechanisms 200, connecting head 214 may be coupled with a fluid-driven tool (e.g., a pneumatic tool, a hydraulic tool, or a sprinkler), and connecting head 224 may be coupled with a fluid-transmitting hose. In one or more example applications of connection mechanism 200, connecting head 214 may be coupled with an automobile door, and connecting head 224 may be coupled with an automobile body. The components of connection mechanism 200 may be made of one or more materials well known in the art, such as plastic, aluminum, copper, iron, steel, and/or stainless steel.

Body 212 may be rotatably coupled with body 222 in a way that first member 210 and second member 220 may swivel with respect to each other for providing improved maneuverability of connection mechanism 200. The rotatable coupling between first member 210 and second member 220 may also enable first member 210 and second member 220 to distribute and share compression forces when connection mechanism 200 is under compression, as discussed with reference to the examples of FIGS. 2B-2F. The mechanism for coupling body 112 with body 122 is further discussed in the example of FIG. 2G.

FIG. 2B shows a schematic representation illustrating a top view of connection mechanism 200 (illustrated in the example of FIG. 2A) in accordance with one or more embodiments of the present invention. When connection mechanism 200 is disposed on the ground, the gravity may act on first member 210 and/or second member 220 to make the rotatably coupled first member 210 and second member 220 coplanar and/or parallel to each other. Alternatively or additionally, when connection mechanism 200 is disposed on the ground and is pressed (and/or run over) by an object, such as a tire of a car, the force exerted by the object may act on first member 210 and/or second member 220 to make the rotatably coupled first member 210 and second member 220 coplanar and/or parallel to each other. In general, when first member 210 and second member 220 are parallel to each other, at least a portion of a passageway structure of first member 210 (represented by an imaginary axis 282) and at least a portion of a passageway structure of second member 220 (represented by an imaginary axis 284) may be parallel to each other.

FIG. 2C shows a schematic representation illustrating a front view of a connection mechanism 200 in stable equilibrium (corresponding to the top view of connection mechanism 200 illustrated in the example of FIG. 2B) in accordance with one or more embodiments of the present invention. As illustrated in the example of FIG. 2B, first member 210 may include a first-member top surface 252, a first-member bottom surface 256, and a first passageway structure 216, wherein first passageway structure 216 is associated with imaginary axis 282 and also illustrated in the example cross-sectional view in FIG. 2G. At least a portion of first passageway structure 216 may be disposed between first-member top surface 252 and first-member bottom surface 256. At least one of first-member top surface 252 and first-member bottom surface 256 may include a curved surface for facilitating the rotation of connection mechanism 200 with respect to the ground to return connection mechanism 200 to a state in which both first member 210 and second member 220 simultaneously contact the ground. In one or more embodiments, each of first-member top surface 252 and first-member bottom surface 256 may be a curved surface.

Second member 220 may include a second-member top surface 262, a second-member bottom surface 266, and a second passageway structure 226; second passageway structure 226 is hidden inside second body 220 in the example of FIG. 2B, associated with imaginary axis 284, and also illustrated in the example cross-sectional view of connection mechanism 200 in FIG. 2G. Second passageway structure 226 may be connected to first passageway structure 216 (as illustrated in the example of FIG. 2G) for accommodating fluid transmission and/or electrical connection. At least a portion of second passageway structure 226 may be disposed between second-member top surface 262 and second-member bottom surface 266. At least one of second-member top surface 262 and second-member bottom surface 266 may include a curved surface also for facilitating the rotation of connection mechanism 200 with respect to the ground to return connection mechanism 200 to a state in which both first member 210 and second member 220 simultaneously contact the ground. In one or more embodiments, each of second-member top surface 262 and second-member bottom surface 266 may be a curved surface.

Whenever the abovementioned portion of first passageway structure 216 is parallel to the abovementioned portion of second passageway structure 226 (e.g., when connection mechanism 200 is at rest on the ground or is pressed by an object), first-member top surface 252 and second-member top surface 262 share a first imaginary tangent plane 250. First imaginary tangent plane 250 may be a tangent to both the first-member top surface and the second-member top surface, wherein first imaginary tangent plane 250 may be perpendicular to both a surface normal vector 254 of first-member top surface 252 and a surface normal vector 264 of second-member top surface 262. An object which presses and/or runs over connection mechanism 200 may contact both first-member top surface 252 and second-member top surface 262 simultaneously, similar to how first imaginary plane 250 contacts both first-member top surface 252 and second-member top surface 262 simultaneously. For example, given that the size of a tire may be substantially larger than the size of connection mechanism 200, the tire surface exerting forces on connection mechanism 200 may be considered substantially flat such that the tire surface may simultaneously contacting first-member top surface 252 and second-member top surface 262 in the way illustrated by first imaginary tangent plane 250. As a result, the forces may be effectively distributed and shared between first member 210 and second member 220.

Similarly, whenever the abovementioned portion of first passageway structure 216 is parallel to the abovementioned portion of second passageway structure 226, first-member bottom surface 256 and second-member bottom surface 266 may share a second imaginary tangent plane 260. Second imaginary tangent plane 260 may be a tangent to both first-member bottom surface 256 and second-member bottom surface 266, wherein second imaginary tangent plane 260 may be perpendicular to both a surface normal vector 258 of first-member bottom surface 256 and a surface normal vector 268 of second-member bottom surface 266. Second imaginary tangent plane 260 may represent the ground on which connection mechanism 200 is disposed. The ground may contact first-member bottom surface 256 and second-member bottom surface 266 simultaneously in the way illustrated by second imaginary tangent plane 260.

As can be appreciated from the discussion above, each of a first compression-exerting object (e.g., the tire) and a second compression-exerting object (e.g., the ground) may contact both the first member 210 and the second member 220 simultaneously. As a result, the compression exerted by the first object and the second object may be effectively distributed and shared between first member 210 and second member 220, such that the compression received by each of first member 210 and second member 220 may be substantially bearable to each of first member 210 and second member 220. Advantageously, connection mechanism 200 may be less prone to damage under compression and may be more durable in comparison with prior-art connection mechanisms.

In one or more embodiments, whenever the abovementioned portion of first passageway structure 216 is parallel to the abovementioned portion of second passageway structure 226, the height H1 of first member 210 may be substantially equal to the height H2 of second member 220. First imaginary tangent plane 250 may be substantially parallel to second imaginary tangent plane 260. Advantageously, compression exerted on connection mechanism 200 may tend to be equally shared by first member 210 and second member 220.

In one or more embodiments, whenever the abovementioned portion of first passageway structure 216 is parallel to the abovementioned portion of second passageway structure 226, the height H1 of first member 210 may be substantially smaller than the height H2 of second member 220, for accommodating particular applications. For example, connection mechanism 200 may be utilized on an uneven ground or a slope, and the difference between height H1 and height 1-12 may improve distribution of compression forces exerted on connection mechanism 200.

In one or more embodiments, for simplifying the manufacturing of connection mechanism 200 and/or improving the distribution of forces in connection mechanism, first passageway structure 216 and second passageway structure 226 may be disposed such that an imaginary axis-containing plane 280 (containing imaginary axis 282 and imaginary axis 284) may be parallel to both first imaginary tangent plane 250 and second imaginary tangent plane 260.

FIG. 2D shows a schematic representation illustrating a front view of connection mechanism 200 in stable equilibrium in accordance with one or more embodiments of the present invention. FIG. 2E shows a schematic representation illustrating a front view of connection mechanism 200 in unstable equilibrium in accordance with one or more embodiments of the present invention. FIG. 2F shows a schematic representation illustrating a front view of connection mechanism 200 in unstable equilibrium in accordance with one or more embodiments of the present invention. Whenever connection mechanism 200 is disposed on the ground 280 with first member 210 being disposed above second member 220 (as illustrated in the example of FIG. 2E) or with second member 220 being disposed above first member 210 (as illustrated in the example of FIG. 2F), connection mechanism 200 (having curved surfaces) may be unstable and may tend to rotate with respect to ground 280 in a direction 288 or in a direction 286 so that connection mechanism 200 may turn into stable equilibrium. Advantageously, when connection mechanism 200 is in stable equilibrium, as illustrated in the example of FIG. 2D or in the example of FIG. 2C, both first member 210 and second member 220 may contact ground 280 (or the ground represented by second imaginary tangent plane 260), and both first member 210 and second member 220 may be ready to share the compression load when an object presses connection mechanism 200, such that the likelihood of damage to connection mechanism 200 may be substantially reduced.

FIG. 2G shows a schematic representation illustrating a cross-sectional view of connection mechanism 200 in accordance with one or more embodiments of the present invention. As illustrated in the example of FIG. 2B, first member 210 may include passageway structure 216 for accommodating a fluid flow and/or for accommodating electrical connection between devices connected by connection mechanism 200; second member 220 may include passageway structure 226, connected to passageway structure 216, for accommodating the fluid flow and/or for accommodating the electrical connection.

In addition to first member 210 and second member 220, connection mechanism 200 may also include a coupling component 230 for rotatably coupling first member 210 with second member 220. Coupling component 230 may cooperate with at least a groove structure 218 of first member 210 and a groove structure 228 disposed at a protrusion 260 of second member 220 to secure protrusion 260 of second member 220 inside a coupling portion 268 of passageway structure 216 of first member 210. Passageway structure 226 may extend through protrusion 260 to connect to passageway structure 216.

As illustrated in the example of FIG. 2G, coupling component 230 may at least partially surround at least a portion of groove structure 228, and groove structure 218 may at least partially surround coupling component 230. In addition, a first portion 232 (or outer portion) of coupling component 230 may be disposed inside groove structure 218, and a second portion 234 (or inner portion) of coupling component 230 may be disposed inside groove structure 228, wherein first portion 232 may at least partially surround second portion 234. Accordingly, a top portion of groove structure 228 and a bottom portion of groove structure 218 may secure (or clamp) coupling component 230 between the top portion of groove structure 228 and the bottom portion of groove structure 218. In turn, by engaging both the bottom portion of groove structure 218 and the top portion of groove structure 228, coupling structure 230 may limit the movement of first member 210 in a breakaway direction 272 with respect to second member 220, and coupling structure 230 may limit the movement of second member 220 in a breakaway direction 274 with respect first member 110. Therefore, coupling component 230 may effectively, securely couple first member 210 with second member 220, preventing first member 210 and second member 220 from breaking off from each other.

At the same time, coupling component 230 may permit first member 210 to swivel or rotate about (an axis 276 of) protrusion 260 of second member 220. By engaging at least one of groove structure 218 and groove structure 228, coupling component 230 may also guide the swiveling movement of first member 210 and/or second member 220. The friction, feature(s), and/or shape(s) of the contact surface(s) of coupling component 230, groove structure 218, and/or groove structure 228 may be properly tuned to optimize the relative swiveling movement of first member 210 and second member 220 and/or to provide desirable tactile feedback to the user of connection mechanism 200. Tuning the friction, feature(s), and/or shape(s) of the contact surface(s) may be performed by, for example, selecting coupling component 230 from a plurality of coupling components.

Also for facilitating the swiveling movement of first member 210 and/or second member 220. Each of first member 210 and second member 220 may include a flat portion to provide a sufficient clearance between first member 210 and second member 220, as illustrated by cross section A-A of body 212 of first member 210 shown in the example of FIG. 2H. Second member 220 may also include a support portion 292 (protruding from body 222) for supporting and guiding a flat bottom portion 294 of body 212 of first member 210 during the swiveling movement, wherein flat bottom portion 294 may contact support portion 292.

In one or more embodiments, coupling component 230 may alternatively or additionally engage one or more other portions of first member 210 and/or second member 220, for optimizing the coupling between first member 210 and second member 220, and/or for optimizing the swiveling operation of first member 210 and/or second member 220. For example, coupling component 230 may engage an inner wall of coupling portion 268 with optimized friction and contact surface features to provide desirable tactile feedback to the user of connection mechanism 200.

In one or more embodiments, connection mechanism 200 may include an electrical connector 238. Electrical connector 238 may include a first conducting terminal 242, a second conducting terminal 244, and a set of conducting media 246 coupled between first conducting terminal 242 and second conducting terminal 244. The set of conducting media 246 may include one or more wires or cables. Each of first conducting terminal 242 and second conducting terminal 244 may include one or more conducting contacts for electrically coupling with at least an electrical and/or electronic device. In addition to providing mechanical connection with the flexibility of swiveling movement, connection mechanism 200 may also advantageously provide electrical connection with the flexibility of swiveling movement. For example, in one or more embodiments, connection mechanism 200 may mechanically and electrically couple an automobile door with an automobile body, wherein electrical connector 238 may transmit signals from a stereo system disposed in the automobile body to one or more speakers disposed at the automobile door. The signals may be reliably transmitted even when the automobile door swivels.

Electrical connector 238 (or at least the set of conducting media 246) may extend through and may be surrounded by at least passageway structure 216 and passageway structure 226. Electrical connector 238 may also extend through a protrusion 260 of second member 220, which is disposed inside passageway structure 216, wherein coupling component 230 may at least partially surround a portion of electrical connector 238. Electrical connector 238 may be protected by the surrounding components such that the reliability of electrical signal transmission may be ensured.

In one or more embodiments, connection mechanism 200 may also include an o-ring 240 disposed between protrusion 260 of second member 220 and body 212 of first member 210. O-ring 240 may prevent fluid leakage at a gap between protrusion 260 and body 212. O-ring 240 may be disposed between coupling component 230 and body 222 of second member 220 (instead of being disposed above coupling component 230), in order to avoid hindering the insertion of the combination of coupling member 230 and protrusion 260 into coupling portion 268. Additionally or alternatively, one or more o-rings may be disposed between passageway structure 216 and coupling member 230, for preventing coupling member 230 from being exposed to the fluid transmitted through passageway structure 216.

Also for facilitating the insertion of the combination of coupling member 230 and protrusion 260 into coupling portion 268, coupling component 230 may need to be compressed to make the outer diameter of coupling component 230 smaller than the diameter D of coupling portion 268. The compression of coupling component 230 is further discussed with reference to the examples of FIGS. 2I and 2J.

FIG. 2H shows a schematic representation illustrating a cross sectional view A-A (indicated in the example of FIG. 2G) of body 212 of first member 210 of connection mechanism 200 in accordance with one or more embodiments of the present invention. As illustrated in the example of FIG. 2H, the perimeter of the cross section of body 212 includes flat bottom portion 294 and a partial circular portion 248. Flat bottom portion 294 may provides a sufficient clearance from second member 220 and may provide a contact surface for facilitating/guiding swiveling movement of first member 210 and/or second member 220. Partial circular portion 248 and at least a portion of passageway structure 216 may be substantially concentric for facilitating the manufacturing of body 212. Partial circular portion 248 may facilitate the rotation of connection mechanism 200 with respect to the ground to return connection mechanism 200 to stable equilibrium with both body 212 of first member 210 and body 222 of second member 220 contacting the ground as illustrated in the example of FIG. 2C or FIG. 2D.

In one or more embodiments, body 212 may have a non-circular cross section for satisfying particular requirements. For example, body 212 may have a substantially square or substantially rectangular cross section for satisfying storage requirements and/or for satisfying load distribution requirements.

FIG. 2I shows a schematic representation illustrating a top view of coupling component 230 of connection mechanism 200 (illustrated in the example of FIGS. 2A-2G) in an uncompressed state in accordance with one or more embodiments of the present invention. Coupling component 230 may be a resilient, compressible C-shaped component made of, for example, steel or stainless steel. Coupling component 230 may include a partial circular portion 296 having a first end 236 and a second end 238, with a gap 298 existing between first end 236 and second end 238. Partial circular portion 296 may be at least half of a circle, for providing sufficient contact surfaces for engaging portions of groove structure 218 and groove structure 228 (illustrated in the example of FIG. 2G). Gap 298 may enable coupling component 230 to be compressed to reduce the outer diameter of coupling component 230, for inserting the combination of coupling component 230 and protrusion 260 of second member 220 (illustrated in the example of FIG. 2G) into coupling portion 268 of first member 210 (illustrated in the example of FIG. 2G). Coupling component 230 in a compressed state is illustrated in the example of FIG. 2J.

FIG. 2J shows a schematic representation illustrating a top view of coupling component 230 in a compressed state in accordance with one or more embodiments of the present invention. As illustrated in the example of FIG. 2J, coupling component 230 may be compressed with first end 236 and second end 238 being brought closer to each other and with the size of gap 298 being reduced. As illustrated in the examples of FIGS. 2I-2J, the outer diameter of coupling component 230 may be reduced from Du2 to Dc2, smaller than the diameter D of coupling portion 268 of first member 210 (illustrated in the example of FIG. 2G), for enabling the combination of coupling component 230 and protrusion 260 of second member 220 (illustrated in the example of FIG. 2G) to be inserted into coupling portion 268 of first member 210.

After the insertion, coupling component 230 may expand to a less compressed state or to the uncompressed state to engage both groove structure 218 and groove structure 228, thereby securely and rotatably coupling first member 210 with second member 220.

FIG. 3A shows a schematic representation illustrating a top view of a coupling component 330 of a connection mechanism in an uncompressed state in accordance with one or more embodiments of the present invention. Coupling component 330 may be employed as a part of connection mechanism 200 in place of coupling component 230 discussed above. In one or more embodiments, a suitable coupling component may be selected from a set of coupling components, e.g., including coupling component 230 and coupling component 330, for perform the aforementioned contact surface tuning.

Coupling component 330 may have a circular shape (or ring shape) and may include a resilient, compressible structure. For example, coupling component 330 may include one or more spring sections, such as spring section 332 and spring section 334. Coupling component may be compressed for reducing the outer diameter of coupling component 330 for facilitating the insertion of the combination of coupling component 330 and protrusion 260 of second member 220 (illustrated in the example of FIG. 2G) into coupling portion 268 of first member 210 (illustrated in the example of FIG. 2G).

FIG. 3B shows a schematic representation illustrating a top view of coupling component 330 in a compressed state in accordance with one or more embodiments of the present invention. As illustrated in the examples of FIGS. 3A-3B, coupling component 330 may be compressed such that the outer diameter of coupling component 330 may be reduced from Du3 to Dc3, smaller than the diameter D of coupling portion 268 of first member 210 (illustrated in the example of FIG. 2G), for enabling the combination of coupling component 230 and protrusion 260 of second member 220 (illustrated in the example of FIG. 2G) to be inserted into coupling portion 268 of first member 210.

After the insertion, coupling component 330 may expand to at least partially resume the outer diameter of coupling component 330, to Du3 or to a value between Du3 and Dc3 if limited by groove structure 218, to engage both groove structure 218 and groove structure 228, thereby securely and rotatably coupling first member 210 with second member 220.

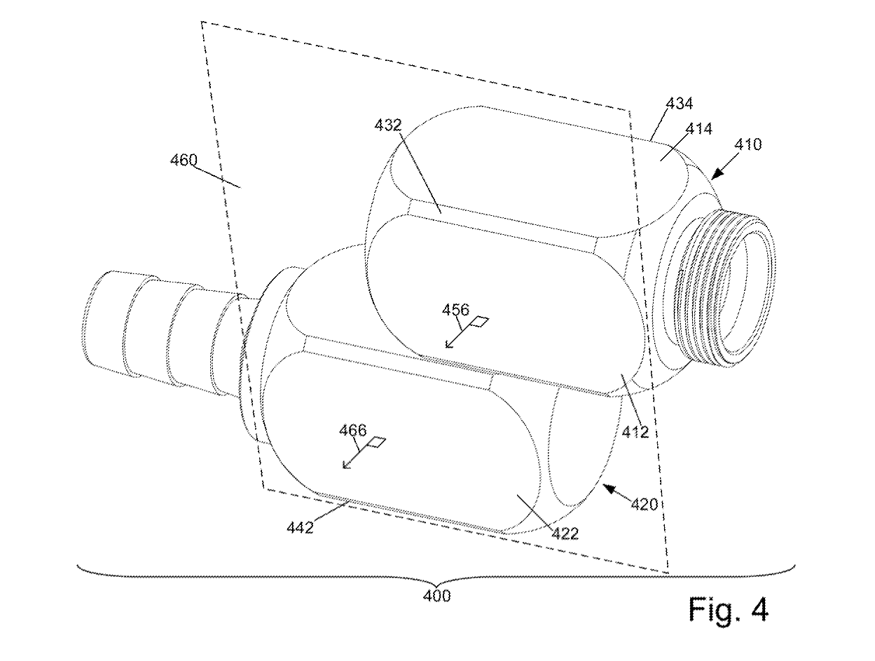

FIG. 4 shows a schematic representation illustrating a perspective view of a connection mechanism 400 in accordance with one or more embodiments of the present invention. As illustrated in the example of FIG. 4, connection mechanism 400 may include a first member 410 and a second member 420, wherein second member 420 may be rotatably coupled with first member 410. Similar to the rotatable coupling between first member 210 and second member 220 discussed above with reference to the examples of FIGS. 2A-3B, the rotatable coupling between first member 410 and second member 420 may provide improved maneuverability of connection mechanism 400, and may enable first member 410 and second member 420 to distribute and share compression forces when connection mechanism 400 is under compression.

In one or more embodiments, connection mechanism 400 may include a first plurality of flat surfaces for simultaneously contacting the ground. Additionally or alternatively, connection mechanism 400 may include a second plurality of flat surfaces for simultaneously contacting an object which exerts compression on connection mechanism 400 (e.g., a tire of a car). Being flat, the flat surfaces may maximize the contact area(s) between connection mechanism 400 and the ground and/or between connection mechanism 400 and the compression-exerting object, thereby facilitating the distribution of compression force for preventing damage to connection mechanism 400.

The first plurality of flat surfaces may include a top surface of first member 410 and a top surface of second member 420. The second plurality of flat surfaces may include a bottom surface of first member 410 and a bottom surface of second member 420. Similar to the structures of connection mechanism 200 illustrated in the examples of FIGS. 2A-2G, a passageway structure of first member 410 may be disposed between the top surface of first member 410 and the bottom surface of first member 410, and a passageway structure of second member 420 may be disposed between the top surface of second member 420 and the bottom surface of second member 420. Whenever the passageway structure of first member 410 is parallel with the passageway structure of second member 420, the top surface of first member 410 may be flush with the top surface of second member 420 such that first member 410 and second member 420 may simultaneously contact the compression-exerting object for sharing compression forces. Additionally or alternatively, whenever the passageway structure of first member 410 is parallel with the passageway structure of second member 420, the bottom surface of first member 410 may be flush with the bottom surface of second member 420 such that first member 410 and second member 420 may simultaneously contact the ground for sharing compression forces.

In the example of FIG. 4, whenever the passageway structure of first member 410 is parallel with the passageway structure of second member 420, a flat surface 412 of first member 410 may be flush with a flat surface 422 of second member 420. Flat surface 412 and flat surface 422 may share an imaginary tangent plane 460, wherein imaginary tangent plane 460 may contain both flat surface 412 and flat surface 422, and wherein imaginary tangent plane 460 may be perpendicular to both a surface normal vector 456 of flat surface 412 and a surface normal vector 466 of flat surface 422.

In one or more embodiments, flat surface 412 of first member 410 and flat surface 422 of second member 420 may present the top surface of first member 410 and the top surface of second member 420, respectively. Flat surface 412 and flat surface 422 may simultaneously contact the compressing-exerting object (e.g., an automotive tire represented by imaginary tangent plane 460) to share the compression forces. Given that the compression forces are shared between first member 410 and second member 420, the compression received by each of first member 410 and second member 420 may be bearable to each of first member 410 and second member 420; therefore, damage to connection 400 may be prevented.

In one or more embodiments, flat surface 412 of first member 410 and flat surface 422 of second member 420 may present the bottom surface of first member 410 and the bottom surface of second member 420, respectively. Flat surface 412 and flat surface 422 may simultaneously contact the ground (e.g., represented by imaginary tangent plane 460) to share the compression forces. Given that the compression forces are shared between first member 410 and second member 420, the compression received by each of first member 410 and second member 420 may be bearable to each of first member 410 and second member 420; therefore, damage to connection 400 may be prevented.

Connection mechanism 400 may include shaped surfaces disposed between the flat surfaces and side surfaces of connection mechanism 400 for facilitating the rotation of connection mechanism 400 with respect to the ground so that mechanism 400 may land on at least both a flat surface of first member 410 and a flat surface of second member 420, to enable first member 410 and second member 420 to share compression forces. For example, connection mechanism 400 may include a shaped surface 432 disposed between flat surface 412 and a side surface 414 of first member 410. Shaped surface 432 may facilitate the rotation of connection member 400 with respect to the ground whenever connection member 400 lands on side surface 414, so that connection member 400 may instead land on flat surfaces 412 and 422 or land on flat surfaces of first member 410 and second member 420 opposite flat surfaces 412 and 422, for enabling first member 410 and second member 420 to share compression forces. Shaped surface 432 may include a flat surface and/or a curved surface.

In one or more embodiments, side surface 414 may include a curved surface such that connection mechanism 400 may be unstable when landing on side surface 414. Accordingly, the gravity (and/or pressing forces exerting by an external object) may generally orient connection mechanism 400 such that both first member 410 and second member 420 may tend to simultaneously contact the ground and simultaneously contact any object pressing connection mechanism 400. Compression exerted on connection mechanism 400 may be shared between first member 410 and second member 420. Advantageously, the likelihood of damage to connection mechanism 400 may be reduced.

As can be appreciated from the foregoing, a connection mechanism in accordance with embodiments of the invention may be automatically oriented by the gravity or by other forces to a flattened (or coplanar) configuration of rotatably connected members of the connection mechanism, such that compression forces received by the connection mechanism may be distributed and/or shared between at least two members of the connection mechanism. In comparison with members of prior art connection mechanisms, each member of a connection mechanism in accordance with embodiments of the invention may receive divided compression and therefore may be more likely to endure the divided, substantially reduced compression. Advantageously, connection mechanisms in accordance with embodiments of the invention may be substantially less prone to damage and may be substantially more durable than prior art connection mechanisms.

Embodiments of the invention may eliminate the need for screws and threads in manufacturing connection mechanisms with swiveling movement capability, such as joint connectors. As a result, precision requirements associated with screws and threads may be eliminated. Advantageously, manufacturing and maintenance costs associated with the connection mechanisms may be minimized, and/or the quality and reliability of the connection mechanisms may be economically provided.

Eliminating the need for screws and threads in manufacturing connection mechanisms, embodiments of the invention may also simplify the assembly process in manufacturing connection mechanisms. Advantageously, embodiments of the invention may improve the efficiency of manufacturing the connection mechanisms; embodiments of the invention may also reduce or prevent errors in manufacturing connection mechanisms, thereby ensuring the quality of the connection mechanisms.

While this invention has been described in terms of several embodiments, there are alterations, permutations, and equivalents, which fall within the scope of this invention. It should also be noted that there are many alternative ways of implementing the methods and apparatuses of the present invention. Furthermore, embodiments of the present invention may find utility in other applications. The abstract section may be provided herein for convenience and, due to word count limitation, may be accordingly written for reading convenience and should not be employed to limit the scope of the claims. It may be therefore intended that the following appended claims be interpreted as including all such alternations, permutations, and equivalents as fall within the true spirit and scope of the present invention.

What is claimed is:

1. A connection mechanism comprising:
a first member including a first-member top surface, a first-member bottom surface, and a first passageway structure, at least a portion of the first passageway structure being disposed between the first-member top surface and the first-member bottom surface; and
a second member rotatably coupled with the first member, the second member including a second-member top surface, a second-member bottom surface, and a second passageway structure, the second passageway structure being connected to the first passageway structure, at least a portion of the second passageway structure being disposed between the second-member top surface and the second-member bottom surface,
wherein whenever the portion of the first passageway structure is parallel to the portion of the second passageway structure, the first-member top surface and the second-member top surface share a first imaginary tangent plane, the first imaginary tangent plane being a tangent to both the first-member top surface and the second-member top surface, the first imaginary tangent plane being perpendicular to both a surface normal vector of the first-member top surface and a surface normal vector of the second-member top surface, and
whenever the portion of the first passageway structure is parallel to the portion of the second passageway structure, the first-member bottom surface and the second-member bottom surface share a second imaginary tangent plane, the second imaginary tangent plane being a tangent to both the first-member bottom surface and the second-member bottom surface, the second imaginary tangent plane being perpendicular to both a surface normal vector of the first-member bottom surface and a surface normal vector of the second-member bottom surface.

2. The connection mechanism of claim 1 wherein
the first-member top surface is a curved first-member top surface, and
the second-member top surface is a curved second-member top surface.

3. The connection mechanism of claim 2 wherein
the first-member bottom surface is a curved first-member bottom surface, and
the second-member bottom surface is a curved second-member bottom surface.

4. The connection mechanism of claim 1 wherein
the first-member top surface is a flat first-member top surface,
the second-member top surface is a flat second-member top surface,
the flat first-member top surface is flush with the flat second-member top surface whenever the portion of the first passageway structure is parallel to the portion of the second passageway structure, and
the first imaginary tangent plane contains both the flat first-member top surface and the flat second-member top surface whenever the portion of the first passageway structure is parallel to the portion of the second passageway structure.

5. The connection mechanism of claim 4 wherein
the first-member bottom surface is a flat first-member bottom surface,
the second-member bottom surface is a flat second-member bottom surface, and
the first imaginary tangent plane contains both the flat first-member bottom surface and the flat second-member bottom surface.

6. The connection mechanism of claim 5 wherein the first member further includes a curved side surface, the curved side surface being connected to the flat first-member top surface, the curved side surface being further connected to the flat first-member bottom surface.

7. The connection mechanism of claim 1 wherein the first imaginary tangent plane is parallel to the second imaginary tangent plane.

8. The connection mechanism of claim 1 wherein the height of first member is equal to the height of second member whenever the portion of the first passageway structure is parallel to the portion of the second passageway structure.

9. The connection mechanism of claim 1 wherein
an imaginary axis of the portion of the first passageway structure and an imaginary axis of the portion of the second passageway structure are both contained in an imaginary axis-containing plane,
the imaginary axis-containing plane is parallel to the first imaginary tangent plane, and the imaginary axis-containing plane is parallel to the second imaginary tangent plane.

10. The connection mechanism for claim 1 further comprising a coupling component coupling the first member with the second member, wherein
the first member further includes a first groove structure,
the second member further includes a second groove structure,
a first portion of the coupling component is disposed inside the first groove structure,
a second portion of the coupling component is disposed inside the second groove structure, and
the first portion of the coupling component at least partially surrounds the second portion of the coupling component.

11. The connection mechanism of claim 10 wherein
the coupling component is a C-shaped component,
a gap exists between a first end of the C-shaped component and a second end of the C-shaped component, and
the shape of the C-shaped component is at least one half of a circle shape.

12. The connection mechanism of claim 10 wherein
the coupling component at least partially surrounds at least a portion of the second groove structure, and
the first groove structure surrounds the coupling component.

13. The connection mechanism of claim 10 wherein a top portion of the second groove structure and a bottom portion of the first groove structure secure the coupling component between the top portion of the second groove structure and the bottom portion of the first groove structure.

14. The connection mechanism of claim 10 wherein
the second member includes a protrusion,
the protrusion includes the second groove structure, and
the protrusion is disposed inside the first passageway structure.

15. The connection mechanism of claim 10 wherein the second passageway structure extends through the protrusion.

16. The connection mechanism of claim 1 further comprising an electrical connector extending through at least the first passageway structure and the second passageway structure.

17. A connection mechanism comprising:
a first member including a first-member top surface, a first-member bottom surface, and a first passageway structure, at least a portion of the first passageway structure being disposed between the first-member top surface and the first-member bottom surface;
a second member rotatably coupled with the first member, the second member including a second-member top surface, a second-member bottom surface, and a second passageway structure, the second passageway structure being connected to the first passageway structure, at least a portion of the second passageway structure being disposed between the second-member top surface and the second-member bottom surface; and
an electrical connector extending through at least the first passageway structure and the second passageway structure,
wherein whenever the portion of the first passageway structure is parallel to the portion of the second passageway structure, the first-member top surface and the second-member top surface share a first imaginary tangent plane, the first imaginary tangent plane being a tangent to both the first-member top surface and the second-member top surface, the first imaginary tangent plane being perpendicular to both a surface normal vector of the first-member top surface and a surface normal vector of the second-member top surface, and
whenever the portion of the first passageway structure is parallel to the portion of the second passageway structure, the first-member bottom surface and the second-member bottom surface share a second imaginary tangent plane, the second imaginary tangent plane being a tangent to both the first-member bottom surface and the second-member bottom surface, the second imaginary tangent plane being perpendicular to both a surface normal vector of the first-member bottom surface and a surface normal vector of the second-member bottom surface.

18. The connection mechanism of claim 17 further comprising a coupling component coupling the first member with the second member, wherein
the first member further includes a first groove structure,
the second member further includes a second groove structure,
a first portion of the coupling component is disposed inside the first groove structure,
a second portion of the coupling component is disposed inside the second groove structure, and
the first portion of the coupling component at least partially surrounds the second portion of the coupling component.

19. The connection of claim 17 wherein
the first-member top surface is a curved first-member top surface,
the second-member top surface is a curved second-member top surface,
the first-member bottom surface is a curved first-member bottom surface, and
the second-member bottom surface is a curved second-member bottom surface,

20. A connection mechanism comprising:
a first member including a first groove structure, a first-member top surface, a first-member bottom surface, and a first passageway structure, at least a portion of the first passageway structure being disposed between the first-member top surface and the first-member bottom surface;
a second member rotatably coupled with the first member, the second member including a second groove structure, a second-member top surface, a second-member bottom surface, and a second passageway structure, the second passageway structure being connected to the first passageway structure, at least a portion of the second passageway structure being disposed between the second-member top surface and the second-member bottom surface; and
a coupling component coupling the first member with the second member,
wherein a first portion of the coupling component is disposed inside the first groove structure,
a second portion of the coupling component is disposed inside the second groove structure,
the first portion of the coupling component at least partially surrounds the second portion of the coupling component,
whenever the portion of the first passageway structure is parallel to the portion of the second passageway structure, the first-member top surface and the second-member top surface share a first imaginary tangent plane, the first imaginary tangent plane being a tangent to both the first-member top surface and the second-member top surface, the first imaginary tangent plane being perpendicular to both a surface normal vector of the first-member top surface and a surface normal vector of the second-member top surface, and
whenever the portion of the first passageway structure is parallel to the portion of the second passageway structure, the first-member bottom surface and the second-member bottom surface share a second imaginary tangent plane, the second imaginary tangent plane being a tangent to both the first-member bottom surface and the second-member bottom surface, the second imaginary tangent plane being perpendicular to both a surface normal vector of the first-member bottom surface and a surface normal vector of the second-member bottom surface.
